(19) United States
(12) Patent Application Publication
(10) Pub. No.: US 2025/0356279 A1
(43) Pub. Date: Nov. 20, 2025

(54) WORK SUPPORT SYSTEM, WORK SUPPORT CONTROL DEVICE, WORK SUPPORT METHOD AND PROGRAM

(71) Applicant: NTT, Inc., Tokyo (JP)

(72) Inventors: Masanobu SAKAMOTO, Musashino-shi, Tokyo (JP); Tomoko SHIBATA, Musashino-shi, Tokyo (JP); Hiroshi YOSHIDA, Musashino-shi, Tokyo (JP); Satoshi TAKATSU, Musashino-shi, Tokyo (JP)

(21) Appl. No.: 18/854,580

(22) PCT Filed: Apr. 12, 2022
(86) PCT No.: PCT/JP2022/017604

§ 371 Date: Oct. 7, 2024

(51) Int. Cl. G06Q 10/0631

(52) U.S. Cl. CPC G06Q 10/063114

(57) ABSTRACT

According to one aspect of the present invention, in a work support control device, work report information input by each user at a time interval recognized by the user as a fixed time during work is acquired from a user terminal, a change state of the time interval is obtained on the basis of the acquired work report information, a degree of concentration of the user on the work is estimated on the basis of the change state, work support information for the user is generated on the basis of the estimated degree of concentration, and the generated work support information is transmitted to the user terminal.

### TECHNICAL FIELD

One aspect of the present invention relates to, for example, a work support system, a work support control device, a work support method, and a program used to support work of an employee.

### BACKGROUND ART

Among various types of work, there is much work that particularly requires concentration, such as driving of a vehicle and production work. In order to safely and efficiently perform this type of work, it is important to provide appropriate support such as instructing an employee to take a break according to the contents of the work.

Therefore, for example, Patent Literature 1 proposes a technique of obtaining a caution-needed time on the basis of time transition of work, setting a refreshing time a predetermined time before the obtained caution-needed time, and notifying an employee of the contents of refreshment in the set refreshing time.

### CITATION LIST

### Patent Literature

Patent Literature 1: JP 2018-159979 A

### SUMMARY OF INVENTION

### Technical Problem

However, the technique described in Patent Literature 1 sets a refreshing time on the basis of a caution-needed time estimated from time transition of each piece of work. Therefore, in a case where a plurality of employees is engaged in the same work, a refreshing time is uniformly set for these employees. That is, when the refreshing time is set, individual differences in the degrees of concentration of the employees on the work are not considered at all.

For this reason, an employee whose concentration continues for a relatively long time is forced to suspend his/her work for refreshment during the work, which causes a decrease in work efficiency. On the other hand, an employee having a relatively short duration of concentration cannot take a break even in a time zone in which concentration has decreased and refreshment is recommended, which may cause trouble in the work.

The present invention has been made in view of the above circumstances, and aims to provide a technique that enables optimal work support according to a concentration state for each user engaged in work.

### Solution to Problem

In order to solve the above problem, in one aspect of a work support system or a work support method according to the present invention, work report information input by each user at a time interval recognized by the user as a fixed time during work is transmitted from a user terminal to a work support control device. Meanwhile, the work support control device obtains a change state of the time interval on the basis of the work report information transmitted from the user terminal, estimates a degree of concentration of the user on the work on the basis of the change state, generates work support information for the user on the basis of the estimated degree of concentration, and transmits the generated work support information to the user terminal.

In addition, in one aspect of a work support control device according to the present invention, work report information input by each user at a time interval recognized by the user as a fixed time during work is acquired from a user terminal, a change state of the time interval is obtained on the basis of the acquired work report information, a degree of concentration of the user on the work is estimated on the basis of the change state, work support information for the user is generated on the basis of the estimated degree of concentration, and the generated work support information is transmitted to the user terminal.

### Advantageous Effects of Invention

According to one aspect of the present invention, the following operational effects can be exhibited. That is, a time interval recognized by a user himself/herself as a fixed time varies depending on the degree of concentration of the user on work. Therefore, monitoring work report information transmitted from the user at the time interval recognized as the fixed time makes it possible to estimate the degree of concentration of the user. Work support for the user is then performed according to the estimated degree of concentration, so that it is possible to perform optimal work support in which an individual difference in the degree of concentration is considered for each user.

That is, according to one aspect of the present invention, it is possible to provide a technique that enables optimal work support according to the degree of concentration for each user engaged in work.

### BRIEF DESCRIPTION OF DRAWINGS

FIG. 1 is a diagram illustrating an example of a work support system according to one embodiment of the present invention.

FIG. 2 is a block diagram illustrating an example of a hardware configuration of a user terminal used in the work support system illustrated in FIG. 1.

FIG. 3 is a block diagram illustrating an example of a software configuration of the user terminal used in the work support system illustrated in FIG. 1.

FIG. 4 is a block diagram illustrating an example of a hardware configuration of a work support control device used in the work support system illustrated in FIG. 1.

FIG. 5 is a block diagram illustrating an example of a software configuration of the work support control device used in the work support system illustrated in FIG. 1.

FIG. 6 is a flowchart illustrating an example of a processing procedure and processing contents of processing executed by a control unit of the user terminal illustrated in FIG. 3.

FIG. 7 is a flowchart illustrating an example of a processing procedure and processing contents of work support control executed by a control unit of the work support control device illustrated in FIG. 5.

FIG. 8 is a flowchart illustrating an example of a processing procedure and processing contents of concentration state estimation processing in the work support control illustrated in FIG. 7.

FIG. 9 is a diagram for describing an example of a work report history for each user.

### DESCRIPTION OF EMBODIMENTS

Hereinafter, embodiments of the present invention will be described with reference to the drawings.

### One Embodiment

In one embodiment of the present invention, for example, a case where work support is provided to a plurality of users engaged in work such as various types of document creation in an office or at home will be described as an example.

Note that the type and contents of work are not limited to the above example, and various examples such as vehicle driving work and production work at a manufacturing site can be considered. Furthermore, even about the work places of the users, various places can be considered for each piece of work.

### Configuration Example

### (1) System

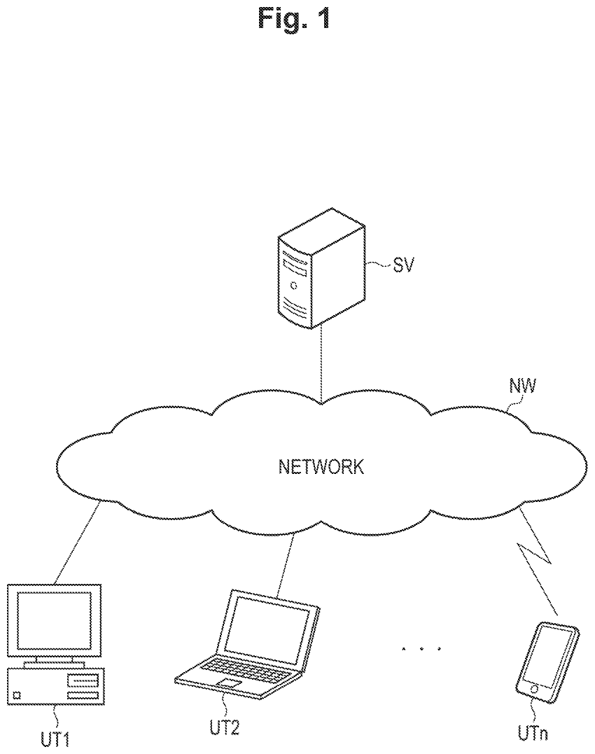

FIG. 1 is a diagram illustrating an example of a configuration of a work support system according to the one embodiment of the present invention.

The work support system according to the one embodiment includes a work support control device SV, and enables information communication via a network NW between the work support control device SV and user terminals UT1 to UTn used by a plurality of users engaged in work. Note that, hereinafter, the user terminals UT1 to UTn are also collectively referred to as UT.

The network NW includes, for example, a wide area network having the Internet as a core, and an access network for accessing the wide area network. As the access network, for example, a public communication network using wired or wireless communication, a local area network (LAN) using wired or wireless communication, or a cable television (CATV) network is used. Note that, in a case where the work support system is operated, for example, in a company or in an office, the network NW is configured by an internal network such as a LAN or a wireless LAN.

### (2) Device

### (2-1) User Terminal UT

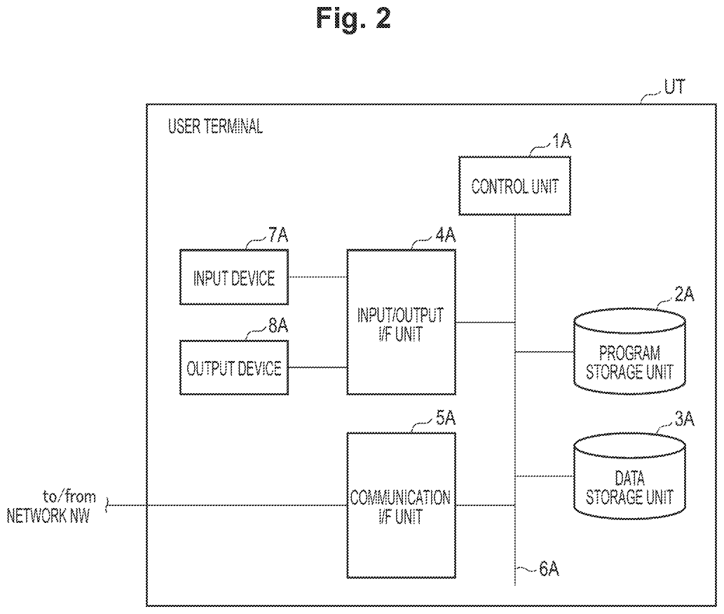

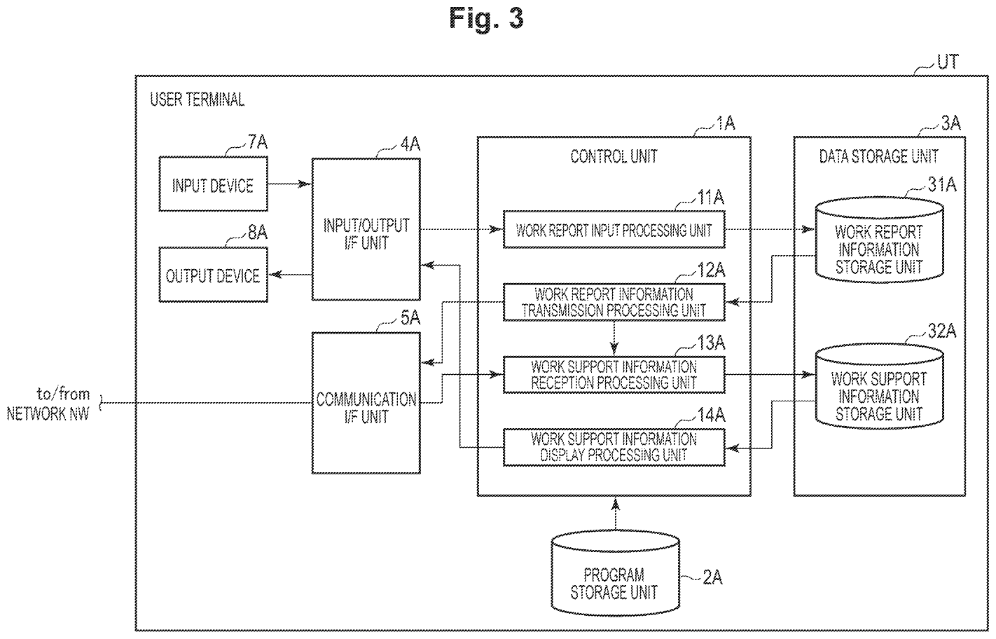

FIGS. 2 and 3 are block diagrams illustrating examples of hardware and software configurations of the user terminal UT.

The user terminal UT includes, for example, a personal computer used by a user for work. Note that, as the user terminal UT, a tablet-type terminal, a smartphone, or the like may also be used.

The user terminal UT includes a control unit 1A using a hardware processor such as a central processing unit (CPU). Furthermore, a storage unit including a program storage unit 2A and a data storage unit 3A, an input/output interface (hereinafter, an interface is referred to as an I/F) unit 4A, and a communication I/F unit 5A are connected to the control unit 1A via a bus 6A.

An input device 7A and an output device 8A are connected to the input/output I/F unit 4A. The input device 7A includes, for example, a keyboard, a mouse, and an operation button, and is used by the user to input data related to document creation work and to input work report information to be described later. The output device 8A includes, for example, a speaker, a light emitting element, and a vibrator in addition to a display, displays various types of display data related to the document creation work, and displays the input work report information and work support information transmitted from the work support control device SV by selectively using visual, auditory, or tactile sensation.

The communication I/F unit 5A performs information communication with the work support control device SV using a communication protocol defined by the network NW under the control of the control unit 1A.

The program storage unit 2A is configured by combining, for example, a non-volatile memory capable of writing and reading as needed, such as a solid state drive (SSD), and a non-volatile memory such as a read only memory (ROM) as storage media, and stores application programs necessary for executing various types of control processing according to the one embodiment, in addition to middleware such as an operating system (OS). Note that, hereinafter, the OS and the application programs are collectively referred to as a program.

The data storage unit 3A is, for example, a combination of a non-volatile memory capable of writing and reading as needed, such as an SSD, and a volatile memory such as a random access memory (RAM) as storage media, and includes a work report information storage unit 31A and a work support information storage unit 32A as main storage units necessary for implementing the one embodiment of the present invention.

The work report information storage unit 31A is used to temporarily store the work report information input by the user until the work report information is transmitted to the work support control device SV.

The work support information storage unit 32A is used to store the work support information transmitted from the work support control device SV.

The control unit 1A includes a work report input processing unit 11A, a work report information transmission processing unit 12A, a work support information reception processing unit 13A, and a work support information display processing unit 14A as processing functions necessary for implementing the one embodiment. Each of the processing units 11A to 14A is implemented by causing the hardware processor of the control unit 1A to execute an application program stored in the program storage unit 2A.

Note that the application program may be downloaded from the work support control device SV, another application server, or the like as necessary and stored in the program storage unit 2A, in addition to being stored in the program storage unit 2A in advance.

The work report input processing unit 11A receives, via the input/output I/F unit 4A, the work report information input by the user on the input device 7A at a time interval recognized by the user himself/herself as a fixed time during work, and stores the received work report information in the work report information storage unit 31A.

Each time the work report information is input, the work report information transmission processing unit 12A reads the work report information from the work report information storage unit 31A, and transmits the work report information from the communication I/F unit 5A to the work support control device SV.

The work support information reception processing unit 13A receives the work support information transmitted from the work support control device SV via the communication I/F unit 5A, and stores the received work support information in the work support information storage unit 32A.

Each time the work support information is received, the work support information display processing unit 14A reads the work support information from the work support information storage unit 32A, generates output data of the work support information, and outputs the generated output data from the input/output I/F unit 4A to the output device 8A.

### (2-2) Work Support Control Device SV

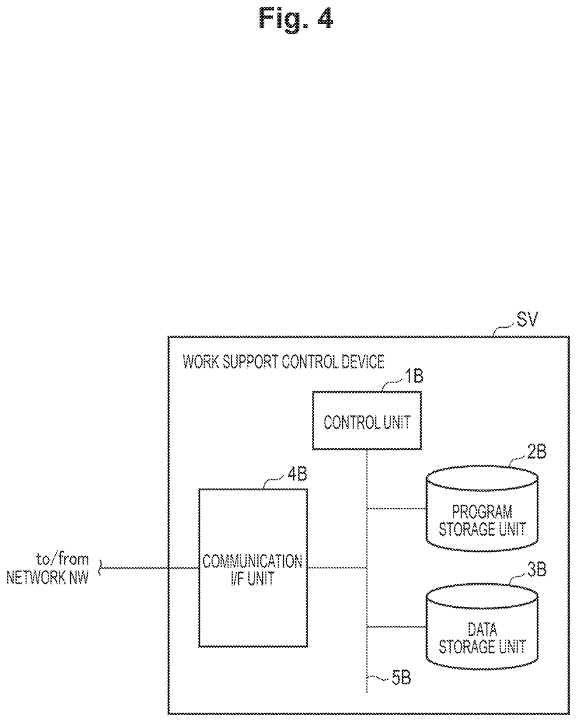

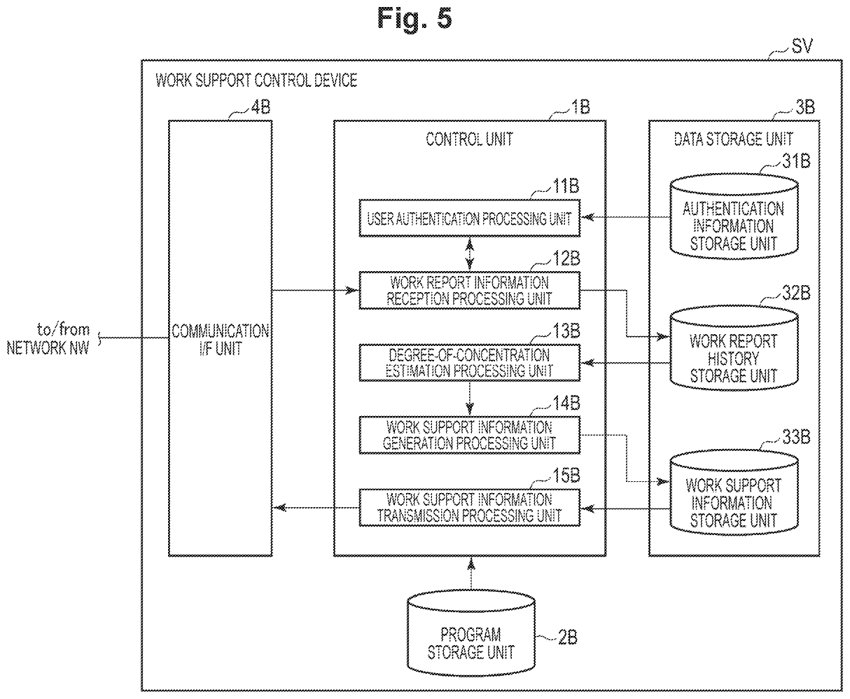

FIGS. 4 and 5 are block diagrams illustrating examples of hardware and software configurations of the work support control device SV, respectively.

The work support control device SV includes, for example, a server computer installed on a web or a cloud. The work support control device SV includes a control unit 1B using a hardware processor such as a CPU, and a storage unit including a program storage unit 2B and a data storage unit 3B and a communication I/F unit 4B are connected to the control unit 1B via a bus 5B.

The communication I/F unit 4B transmits and receives information data to and from each of the user terminals UT1 to UTn using a communication protocol defined by the network NW under the control of the control unit 1B.

The program storage unit 2B is configured by combining, for example, a non-volatile memory capable of writing and reading as needed, such as an HDD or an SSD, and a non-volatile memory such as a ROM as storage media, and stores programs necessary for executing various types of control processing according to the one embodiment of the present invention, in addition to middleware such as an OS.

The data storage unit 3B is, for example, a combination of a non-volatile memory capable of writing and reading as needed, such as an HDD or an SSD, and a volatile memory such as a RAM as storage media, and includes an authentication information storage unit 31B, a work report history storage unit 32B, and a work support information storage unit 33B.

The authentication information storage unit 31B stores authentication information for performing authentication processing on each user to be supported.

The work report history storage unit 32B stores, for each user, work report information transmitted from the user terminals UT1 to UTn according to time series.

The work support information storage unit 33B stores work support information generated for each user until the work support information is transmitted to the corresponding user terminals UT1 to UTn.

The control unit 1B includes a user authentication processing unit 11B, a work report information reception processing unit 12B, a degree-of-concentration estimation processing unit 13B, a work support information generation processing unit 14B, and a work support information transmission processing unit 15B as processing functions according to the one embodiment of the present invention. Each of the processing units 11B to 15B is implemented by causing the hardware processor of the control unit 1B to execute an application program stored in the program storage unit 2B.

Note that some or all of the processing units 11B to 15B may be implemented by use of hardware such as a large scale integration (LSI) or an application specific integrated circuit (ASIC).

In a case where work report information transmitted from one of the user terminals UT is received by the work report information reception processing unit 12B to be described later, the user authentication processing unit 11B authenticates the transmission source user (report user) of the received work report information on the basis of authentication information registered in advance in the authentication information storage unit 31B. The user authentication processing unit 11B then passes identification information (user ID) of the authenticated report user to the work report information reception processing unit 12B.

The work report information reception processing unit 12B receives each piece of work report information transmitted from the user terminals UT1 to UTn via the communication I/F unit 4B. The work report information reception processing unit 12B then associates the received work report information with each of the user ID specified by the authentication processing of the user authentication processing unit 11B and the reception time clocked by a clock function incorporated in the work report information reception processing unit 12B to generate a work report history for each user, and stores the generated work report history in the work report history storage unit 32B.

The degree-of-concentration estimation processing unit 13B determines, for each user, a change in a reception time interval between pieces of work report information on the basis of the work report history stored in the work report history storage unit 32B, and estimates the degree of concentration of the user on work on the basis of the change in the time interval. An example of the processing of estimating the degree of concentration of the user will be described in an operation example.

The work support information generation processing unit 14B generates information including work support contents appropriate for the user according to the degree of concentration of the user estimated by the degree-of-concentration estimation processing unit 13B. The work support information generation processing unit 14B then temporarily stores the generated work support information in association with the user ID in the work support information storage unit 33B.

The work support information transmission processing unit 15B reads the work support information from the work support information storage unit 33B each time the work support information is generated by the work support information generation processing unit 14B. The work support information transmission processing unit 15B then transmits the read work support information from the communication I/F unit 4B to one of the user terminals UT1 to UTn corresponding to the notification destination user.

### (Operation Example)

Next, an operation example of the work support system configured as described above will be described.

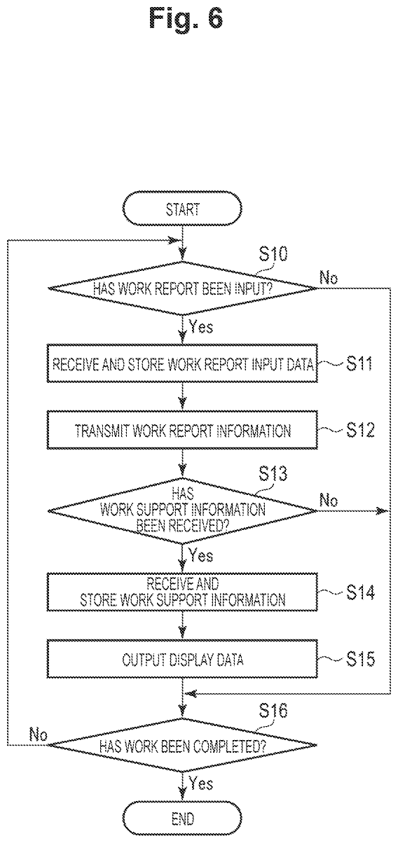

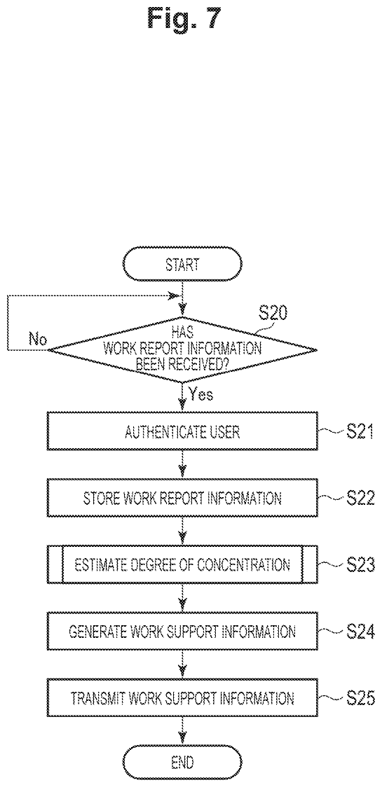

FIG. 6 is a flowchart illustrating an example of a procedure and processing contents of processing executed by the control unit 1A of one of the user terminals UT, and FIG. 7 is a flowchart illustrating an example of a procedure and processing contents of processing executed by the control unit 1B of the work support control device SV.

### (1) Input and Transmission of Work Report Information

Each user is obliged to make a work report at a time interval recognized by the user himself/herself as a fixed time during work. Note that the time interval for the work report is set to, for example, one hour, but may be other time, and can be arbitrarily set according to the type of work. Furthermore, the time interval may be set to, for example, the same value for each user by the system, or may be arbitrarily set by each user individually.

During work, a user inputs, on the input device 7A, work report information at the above time interval recognized by the user as the fixed time. It is desirable that information indicating the progress status of the work at that time be input as work report information. However, in a case where report contents are undetermined or in a case where the user is performing a task with which the user is tied up, for example, it is only necessary to press a report button included in the input device 7A.

The control unit 1A of the user terminal UT monitors the operation of inputting the work report information in step S10. In this state, when the user operates the input device 7A to input the work report information as described above, in step S11, the control unit 1A of the user terminal UT acquires the work report information input by the input device 7A via the input/output I/F unit 4A under the control of the work report input processing unit 11A, and stores the acquired work report information in the work report information storage unit 31A.

Note that, at this time, the work report information may be given, for example, an input start time or end time as a report time. Furthermore, the work report information may be given identification information of the user or the user terminal UT.

Next, in step S12, the control unit 1A of the user terminal UT reads the work report information from the work report information storage unit 31A under the control of the work report information transmission processing unit 12A. The read work report information is then transmitted from the communication I/F unit 5A to the work support control device SV.

### (2) Reception and Storage of Work Report Information

In step S20, the control unit 1B of the work support control device SV monitors reception of work report information from the user terminals UT under the control of the work report information reception processing unit 12B.

When work report information is received via the communication I/F unit 4B, in step S21, the control unit 1B of the work support control device SV performs authentication processing for the user who is the transmission source of the work report information with reference to authentication information stored in the authentication information storage unit 31B under the control of the user authentication processing unit 11B. As a result of the authentication, when the transmission source user is a user registered in advance, the authenticated information is returned to the work report information reception processing unit 12B together with the user ID.

Upon receiving the authenticated information and the user ID, in step S22, the work report information reception processing unit 12B stores the received work report information in the work report history storage unit 32B in association with each of the user ID and the reception time clocked by the incorporated clock function. As a result, the work report information transmitted from each of the user terminals UT is organized in chronological order for each user and stored as a work report history in the work report history storage unit 32B.

Note that, in a case where work report information is given a report time, the work report information reception processing unit 12B may store the work report information in the work report history storage unit 32B according to the report time. In addition, in a case where work report information is given a user ID, the work report information may be collectively stored in the work report history storage unit 32B for each user ID.

### (3) Estimation of Degree of Concentration of User

Each time new work report information is received from one of the user terminals UT, in step S23, the control unit 1B of the work support control device SV estimates the degree of concentration of the user under the control of the degree-of-concentration estimation processing unit 13B as follows.

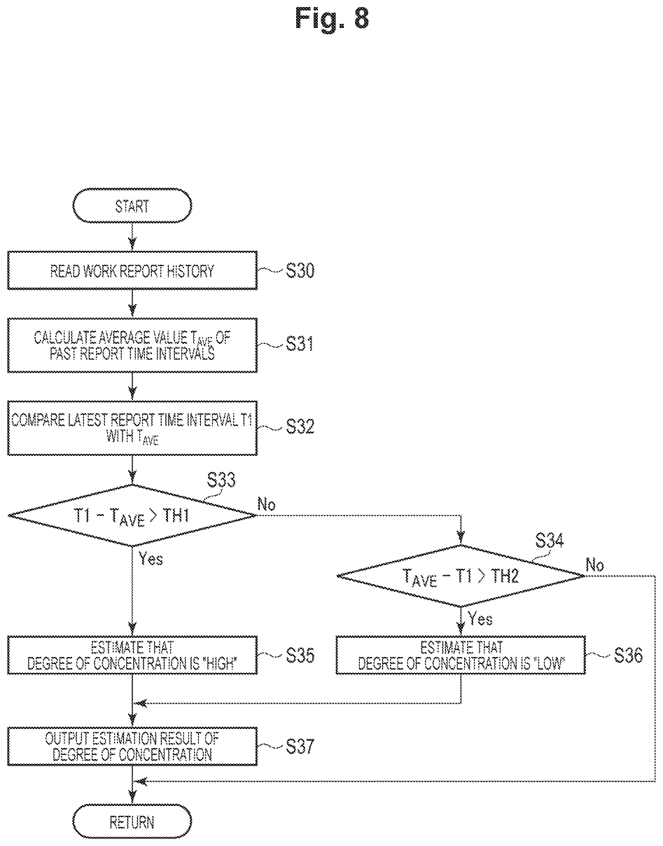

FIG. 8 is a flowchart illustrating an example of a procedure and processing contents of estimation processing executed by the degree-of-concentration estimation processing unit 13B.

First, in step S30, the degree-of-concentration estimation processing unit 13B reads the work report history of the user corresponding to the newly received work report information from the work report history storage unit 32B. Subsequently, in step S31, the degree-of-concentration estimation processing unit 13B obtains time intervals between pieces of work report information on the basis of the report time or the reception time of the pieces of work report information from the past to the latest included in the read work report history, and further calculates an average value T_{AVE} of the time intervals.

Next, in step S32, the degree-of-concentration estimation processing unit 13B compares a time interval T₁ between the latest work report information and the previously received work report information with the average value T_{AVE} of the time intervals between the pieces of past work report information, and calculates a difference therebetween.

In step S33, the degree-of-concentration estimation processing unit 13B then determines whether or not a value obtained by subtracting the average value T_{AVE} of the past time intervals from the latest time interval T₁ (T₁−T_{AVE}) is larger than a first threshold value TH₁. As a result of this determination, when

$${T}_{1} - {T}_{AVE} > {TH}_{1}$$

is satisfied, in step S35, the degree-of-concentration estimation processing unit 13B estimates that the latest degree of concentration of the user is maintained in a high state (degree of concentration “high”).

On the other hand, in a case where T₁−T_{AVE}>TH₁ is not satisfied, in step S34, the degree-of-concentration estimation processing unit 13B determines whether or not a value obtained by subtracting the latest time interval T₁ from the average value T_{AVE} of the past time intervals (T_{AVE}−T₁ is larger than a second threshold value TH₂. As a result of this determination, when

$${T}_{AVE} - {T}_{1} > {TH}_{2}$$

is satisfied, in step S36, the degree-of-concentration estimation processing unit 13B estimates that the latest degree of concentration of the user has decreased (degree of concentration “low”).

Note that the first threshold value TH; and the second threshold value TH₂ may be set to different values, but may be set to the same value, and the values are only required to be set according to an allowable range when the degree of concentration is determined.

In step S37, the degree-of-concentration estimation processing unit 13B then outputs information indicating the estimation result of the degree of concentration of the user obtained in step S35 or step S36 to the work support information generation processing unit 14B.

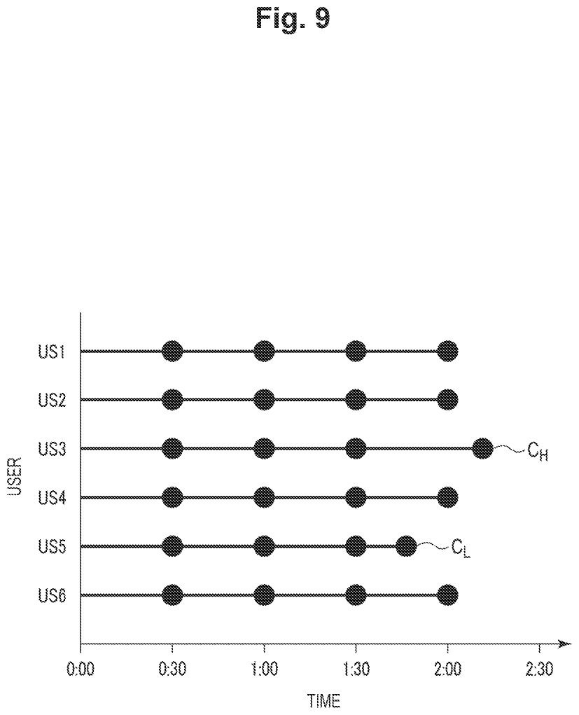

FIG. 9 illustrates an example of work report histories of users US1 to US6. In the example of FIG. 9, the time interval of the latest work report information C_{H} of the user US3 is clearly longer than the average value of the time intervals of the past work report information of the user US3. Therefore, it is estimated that the latest degree of concentration of the user US3 is maintained in a high state.

On the other hand, for example, the time interval of the latest work report information C_{L} of the user US5 is clearly shorter than the average value of the time intervals of the past work report information of the user US5. Therefore, it is estimated that the latest degree of concentration of the user US5 has decreased.

### (4) Generation and Transmission of Work Support Information

Next, in step S24, the control unit 1B of the work support control device SV generates work support information for the corresponding user according to the estimation result of the degree of concentration under the control of the work support information generation processing unit 14B.

For example, for a user whose degree of concentration is estimated to be “low”, the work support information generation processing unit 14B generates work support information including a message for encouraging a break or refreshment. On the other hand, for a user whose degree of concentration is estimated to be “high”, the work support information generation processing unit 14B generates work support information including a message for evaluating an effort for work, such as “You're doing well” or “Keep up the good work”, instead of a message for instructing the user to take a break or to be refreshed.

Note that, although a case where a message for visual display is generated has been described in the above example, voice data of the message may be generated. Furthermore, in a case where a break is simply encouraged, control data for generating light blinking or vibration defined in advance as a sign of break encouragement may be generated.

In addition, as a message included in the work support information, a standard message stored in advance may be used, but a message corresponding to the report contents of the work report information may be generated. For example, the progress status or difficulty level of the work may be determined from the report contents included in the work report information, and a message corresponding to the progress status or difficulty level may be generated. Note that the analysis of the report contents can be performed by, for example, morphological analysis and using work schedule information registered in advance, but may be implemented by use of a learning model learned by machine learning.

The work support information generation processing unit 14B temporarily stores the generated work support information in association with the user ID in the work support information storage unit 33B.

Subsequently, in step S25, the control unit 1B of the work support control device SV reads the work support information for each user from the work support information storage unit 33B under the control of the work support information transmission processing unit 15B. The work support information transmission processing unit 15B then transmits the read work support information from the communication I/F unit 4B to the corresponding user terminal UT on the basis of the user ID associated with the work support information.

Note that the transmission timing of the work support information is desirably set to a timing immediately after the estimation result of the degree of concentration is obtained, but may be appropriately adjusted according to the report contents of the work report information. For example, as a result of analyzing the report contents of the work report information, in a case where it is determined that the user is performing a task with which the user is tied up, the transmission timing may be set such that the work support information is transmitted after a certain period of time or after a period of time until the task reaches a certain stage.

### (5) Reception and Output of Work Support Information

In step S13, the control unit 1A of the user terminal UT monitors the transmission of the work support information from the work support control device SV. In this state, when the work support information addressed to the own terminal is transmitted from the work support control device SV, in step S14, the control unit 1A of the user terminal UT receives the work support information via the communication I/F unit 5A under the control of the work support information reception processing unit 13A. The work support information reception processing unit 13A then stores the received work support information in the work support information storage unit 32A.

Next, in step S15, the control unit 1A of the user terminal UT reads the work support information from the work support information storage unit 32A, and generates display data of a message included in the read work support information under the control of the work support information display processing unit 14A. The work support information display processing unit 14A then outputs the generated display data from the input/output I/F unit 4A to the output device 8A, and causes the output device 8A to display the display data on the display.

As a result, displaying the message of the work support information enables the user to receive work support having contents corresponding to the degree of concentration of the user at that time. For example, in a case where the degree of concentration has decreased, the user is encouraged to take a break or to be refreshed. On the other hand, in a case where the degree of concentration is maintained in a high state, the user is not forced to take a break or to be refreshed, and thus, the work efficiency does not decrease. Moreover, presenting the evaluation message enables the user to further increase his/her motivation for an effort for the work.

Note that, in a case where the work support information includes voice data of the work support message, the work support information display processing unit 14A outputs the voice data to the output device 8A via the input/output I/F unit 4A, and causes the speaker to output the voice data as a voice message. Furthermore, in a case where the work support information includes, for example, control data for encouraging a break, the work support information display processing unit 14A outputs the control data to the output device 8A via the input/output I/F unit 4A. As a result, the output device 8A drives, for example, the light emitting element or the vibrator, and instructs the user to take a break or the like by light blinking or vibration.

### (Operations and Effects)

As described above, in the one embodiment, the work support control device SV receives, from the user terminal UT, work report information input at a time interval recognized by a user as a fixed time, and stores the work report information as a work report history. On the basis of the work report history, the work support control device SV determines whether the time interval of the latest work report is longer or shorter than the average value of the time intervals of the past work reports, thereby estimating the degree of concentration of the user. Work support information for the user is then generated on the basis of the estimation result of the degree of concentration, and the generated work support information is transmitted to the user terminal UT.

Therefore, it is possible to perform appropriate work support according to the degree of concentration for the user. For example, a user whose degree of concentration has decreased is encouraged to take a break or to be refreshed at that time. As a result, the motivation of the user for the work is recovered, whereby the work quality can be maintained. On the other hand, for example, a user whose degree of concentration is maintained in a high state is not instructed to take a break or to be refreshed, and instead, an evaluation message for praising an effort for the work is presented. As a result, the user is not forced to take a break or to be refreshed, and the work efficiency does not decrease. Moreover, presenting the evaluation message enables the user to further increase his/her motivation for an effort for the work.

### Other Embodiments

In the one embodiment described above, an example has been described in which the work support control device SV is provided on a web or a cloud, and work support for a plurality of users is collectively performed by the work support control device SV. However, the present invention is not limited thereto, and for example, the function of the work support control device may be provided in a user terminal, and work support according to the degree of concentration may be performed for each user.

In addition, the hardware configurations and the software configurations of the user terminal and the work support control device, the respective processing procedures and processing contents, the procedure and processing contents of the processing of estimating the degree of concentration, the procedure and processing contents of the processing of generating work support information, and the like can be variously modified and implemented without departing from the gist of the present invention.

Although the embodiments of the present invention have been described in detail, the description provided above is merely an example of the present invention in all respects. It is needless to say that various improvements and modifications can be made without departing from the scope of the present invention. That is, in carrying out the present invention, a specific configuration according to an embodiment may be appropriately adopted.

In short, the present invention is not limited to the above embodiments without any change, but can be embodied by modifying the components without departing from the gist of the invention at the implementation stage. In addition, various inventions can be made by appropriately combining a plurality of components disclosed in the above-described embodiments. For example, some components may be deleted from all the components shown in the embodiments. Furthermore, components in different embodiments may be combined as appropriate.

### REFERENCE SIGNS LIST

SV Work support control device
UT, UT1 to UTn User terminal
NW Network
1A, 1B Control unit
2A, 2B Program storage unit
3A, 3B Data storage unit
4A Input/output I/F unit
5A, 4B Communication I/F unit
6A, 5B Bus
7A Input device
8A Output device
11A Work report input processing unit
12A Work report information transmission processing unit
13A Work support information reception processing unit
14A Work support information display processing unit
11B User authentication processing unit
12B Work report information reception processing unit
13B Degree-of-concentration estimation processing unit
14B Work support information generation processing unit
15B Work support information transmission processing unit
31A Work report information storage unit
32A Work support information storage unit
31B Authentication information storage unit
32B Work report history storage unit
33B Work support information storage unit

1. A work support system comprising: a user terminal used by a user engaged in work; and a work support control device capable of performing information communication with the user terminal, wherein
the user terminal includes
a report processing unit configured to transmit, to the work support control device, work report information input at a time interval recognized by the user as a fixed time during work, and
the work support control device includes:
a reception processing unit configured to receive the work report information transmitted from the user terminal;
an estimation processing unit configured to obtain a change state of the time interval on a basis of the received work report information and estimate a degree of concentration of the user on the work on a basis of the change state; and
a notification processing unit configured to generate work support information for the user according to the estimated degree of concentration, and transmit the generated work support information to the user terminal.

2. A work support control device capable of performing information communication with a user terminal used by a user engaged in work, the work support control device comprising:
a first processing unit configured to receive, from the user terminal, work report information input at a time interval recognized by the user as a fixed time during work;
a second processing unit configured to obtain a change state of the time interval on a basis of the received work report information and estimate a degree of concentration of the user on the work on a basis of the change state; and
a third processing unit configured to generate work support information for the user according to the estimated degree of concentration, and transmit the generated work support information to the user terminal.

3. The work support control device according to claim 2, wherein, each time the work report information is received, the second processing unit is configured to calculate the latest time interval on a basis of a reception timing of the work report information, and estimate the degree of concentration of the user on the work on a basis of a change in the latest time interval with respect to an average value of a plurality of the time intervals calculated in past.

4. The work support control device according to claim 3, wherein the second processing unit is configured to estimate that the degree of concentration is high in a case where the latest time interval is longer than the average value of the time intervals by a first value or more, and estimate that the degree of concentration has decreased in a case where the latest time interval is shorter than the average value of the time intervals by a second value or more.

5. The work support control device according to claim 4, wherein the third processing unit is configured to transmit the work support information to the user terminal at a time of estimation in a case where the degree of concentration is estimated to have decreased, and postpone transmission of the work support information to the user terminal in a case where the degree of concentration is estimated to be high.

6. The work support control device according to claim 2, wherein the third processing unit includes information for encouraging a break in the work support information, and is configured to generate information indicating work support contents corresponding to a progress status of the work on a basis of the work report information, and includes the generated information indicating the work support contents in the work support information.

7. A work support method executed by a work support system including a user terminal used by a user engaged in work and a work support control device capable of performing information communication with the user terminal, the work support method comprising:
transmitting, by the user terminal, to the work support control device, work report information input at a time interval recognized by the user as a fixed time during work;
receiving, by the work support control device, the work report information transmitted from the user terminal;
obtaining, by the work support control device, a change state of the time interval on a basis of the received work report information and estimating a degree of concentration of the user on the work on a basis of the change state; and
generating, by the work support control device, work support information for the user according to the estimated degree of concentration, and transmitting the generated work support information to the user terminal.

8. A non-transitory computer readable medium storing a program, wherein execution of the program causes a processor to perform operations of claim 7.
